(19) United States
(12) Patent Application Publication
(10) Pub. No.: US 2024/0001162 A1
(43) Pub. Date: Jan. 4, 2024

(54) SYSTEM AND METHOD OF INTEGRATION OF A FIRE HOSE WITH A BREATHABLE AIR SUPPLY SYSTEM

(71) Applicant: Anthony J. Turiello, Westlake, TX (US)

(72) Inventor: Anthony J. Turiello, Westlake, TX (US)

(21) Appl. No.: 18/213,841

(22) Filed: Jun. 25, 2023

Related U.S. Application Data
(60) Provisional application No. 63/357,632, filed on Jun. 30, 2022.
(60) Provisional application No. 63/357,721, filed on Jul. 1, 2022.
(60) Provisional application No. 63/357,723, filed on Jul. 1, 2022.
(60) Provisional application No. 63/356,996, filed on Jun. 29, 2022.

(51) Int. Cl. A62B 7/12; A62C 33/00; A62B 9/04

(52) U.S. Cl. CPC A62B 7/12; A62B 9/04; A62C 33/00

(57) ABSTRACT

A breathable air supply system within a structure includes a fixed piping system permanently installed therewithin serving as a source of breathable air, and an emergency air fill site communicatively coupled to the fixed piping system to port a regulated, pressurized volume of the breathable air out through a first connector thereof. The first connector is connectably complementary to a second connector of a fire hose configured to carry a fire suppression agent through a first channel thereof. The second connector is communicatively coupled to a second channel of the fire hose separate from the first channel and configured to carry the regulated, pressurized volume of the breathable air therethrough to an SCBA of a user. Connection of the first connector to the second connector supplies the regulated, pressurized volume of the breathable air through the second channel to an end of the fire hose couplable to the SCBA.

### CLAIM OF PRIORITY

This Application is a conversion application of, and claims priority to, U.S. Provisional Patent Application No. 63/357,632 titled FIRE HOSE PANEL TO SUPPLY LOW-PRESSURE BREATHABLE AIR TRANSPORTED THROUGH FIXED PIPING OF A STRUCTURE TO A SELF-CONTAINED BREATHING APPARATUS THROUGH A FIRE HOSE filed on Jun. 30, 2022, U.S. Provisional Patent Application No. 63/357,721 titled FILL PANEL OF A FIREFIGHTER AIR REPLENISHMENT SYSTEM HAVING DUAL HIGH-PRESSURE AND LOW-PRESSURE PORTS TO BOTH FILL SELF-CONTAINED BREATHING APPARATUS CANISTERS AND SUPPLY BREATHABLE AIR THROUGH A FIRE HOSE filed on Jul. 1, 2022, U.S. Provisional Patent Application No. 63/357,723 titled PNEUMATIC TOOL POWERED THROUGH A FIRE HOSE USING PRESSURIZED AIR TRANSPORTED THROUGH A FILL PANEL OF A FIREFIGHTER AIR REPLENISHMENT SYSTEM OR A FIRE HOSE PANEL filed on Jul. 1, 2022, and U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022. The contents of each of the aforementioned applications are incorporated herein by reference in entirety thereof.

### FIELD OF TECHNOLOGY

This disclosure relates generally to emergency systems and, more particularly, to systems and/or a method of integration of a fire hose with a breathable air supply system.

### BACKGROUND

A structure (e.g., a vertical building, a horizontal building, a tunnel, marine craft) may have a Firefighter Air Replenishment System (FARS) implemented therein. The structure may have an emergency air fill site therein to enable firefighters and/or emergency personnel inhale safe air through face-pieces of respirators or Self-Contained Breathing Apparatuses (SCBAs) thereof that have connectors couplable to complementary connectors on fill hoses of the emergency air fill site. However, the setup may be inconvenient for the firefighters and/or the emergency personnel to be able to attempt to extinguish fires associated with the structure while simultaneously leveraging the emergency air fill site to inhale safe air through the SCBAs thereof.

### SUMMARY

Disclosed are systems and/or a method of integration of a fire hose with a breathable air supply system.

In one aspect, a breathable air supply system within a structure includes a fixed piping system permanently installed within the structure serving as a source of breathable air, and an emergency air fill site communicatively coupled to the fixed piping system to port a regulated, pressurized volume of the breathable air out through a first connector thereof. The first connector is connectably complementary to a second connector of a fire hose configured to carry a fire suppression agent (e.g., a firefighting fluid in general, water, gas, aqueous film-forming foam, compositions containing water) through a first channel thereof. The second connector is at a first end of the fire hose and communicatively coupled to a second channel of the fire hose separate from the first channel. The second channel is configured to carry the regulated, pressurized volume of the breathable air therethrough to a Self-Contained Breathing Apparatus (SCBA) of a user. Connection of the first connector to the second connector supplies the regulated, pressurized volume of the breathable air through the second channel to a second end of the fire hose couplable to the SCBA of the user.

The emergency air fill site communicatively coupled to the fixed piping system may be an emergency air fill panel or a rupture containment air fill station stationed at a level within the structure. The first connector may be at a free end of a fill hose extending from the emergency air fill panel. The second channel may be constituted by another fill hose coursing through the fire hose to the second end thereof. The another fill hose may be couplable to the fill hose of the emergency air fill panel. The emergency air fill panel may include a third connector provided on a main frame thereof to which the fill hose is connected and from which the fill hose extends to the free end thereof. The another fill hose may include a fourth connector proximate the second end of the fire hose couplable to a fifth connector of the SCBA. The fourth connector of the another fill hose and the fifth connector of the SCBA may be a female component and a male component respectively of a coupling therebetween such that the fourth connector receives a protruding element of the fifth connector therein and locks on to the fifth connector by way of a locking element of the fourth connector.

In another aspect, a breathable air supply system within a structure includes a fixed piping system permanently installed within the structure serving as a source of breathable air, and an emergency air fill site communicatively coupled to the fixed piping system to port a regulated, pressurized volume of the breathable air out through a first connector thereof. The breathable air supply system also includes a fire hose configured to carry a fire suppression agent through a first channel thereof and to carry the regulated, pressurized volume of the breathable air through a second channel thereof to an SCBA of a user. The second channel is separate from the first channel. The fire hose includes a second connector at a first end thereof communicatively coupled to the second channel. The first connector is connectably complementary to the second connector of the fire hose. Connection of the first connector to the second connector supplies the regulated, pressurized volume of the breathable air through the second channel to a second end of the fire hose couplable to the SCBA of the user.

In yet another aspect, a method of integration of a fire hose configured to carry a fire suppression agent through a first channel thereof with a breathable air supply system within a structure having a fixed piping system installed therein to supply breathable air from a source across the breathable air supply system including an emergency air fill site configured to port a regulated, pressurized volume of the breathable air out through a first connector thereof is disclosed. The method includes providing the first connector of the emergency air fill site as connectably complementary to a second connector of the fire hose. The second connector is at a first end of the fire hose and communicatively coupled to a second channel of the fire hose separate from the first channel. The second channel is configured to carry the regulated, pressurized volume of the breathable air therethrough to an SCBA of a user. The method also includes supplying the regulated, pressurized volume of the breathable air through the second channel to a second end of the fire hose couplable to the SCBA of the user based on connection of the first connector to the second connector.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a safety system associated with a structure, according to one or more embodiments.

FIG. 2 is a schematic view of an example fire hose, according to one or more embodiments.

FIG. 3A is a schematic view of an emergency air fill panel as an example emergency air fill site of the safety system of FIG. 1, according to one or more embodiments.

FIG. 3B is a schematic view of a rupture containment air fill station as another example emergency air fill site of the safety system of FIG. 1, according to one or more embodiments.

FIG. 4 is a schematic view of a connection between a connector of the emergency air fill panel of FIG. 3A and a connector of the fire hose of FIG. 2, according to one or more embodiments.

FIG. 5 is a process flow diagram detailing the operations involved in integrating a fire hose with a breathable air supply system, according to one or more embodiments.

FIG. 6 is a schematic view of another layout of the safety system of FIG. 1 with emergency responders at each level of the structure thereof, according to one or more embodiments.

Other features of the present embodiments will be apparent from the accompanying drawings and from the detailed description that follows.

### DETAILED DESCRIPTION

Example embodiments, as described below, may be used to provide systems and/or a method of integration of a fire hose with a breathable air supply system. Although the present embodiments have been described with reference to specific example embodiments, it will be evident that various modifications and changes may be made to these embodiments without departing from the broader spirit and scope of the various embodiments.

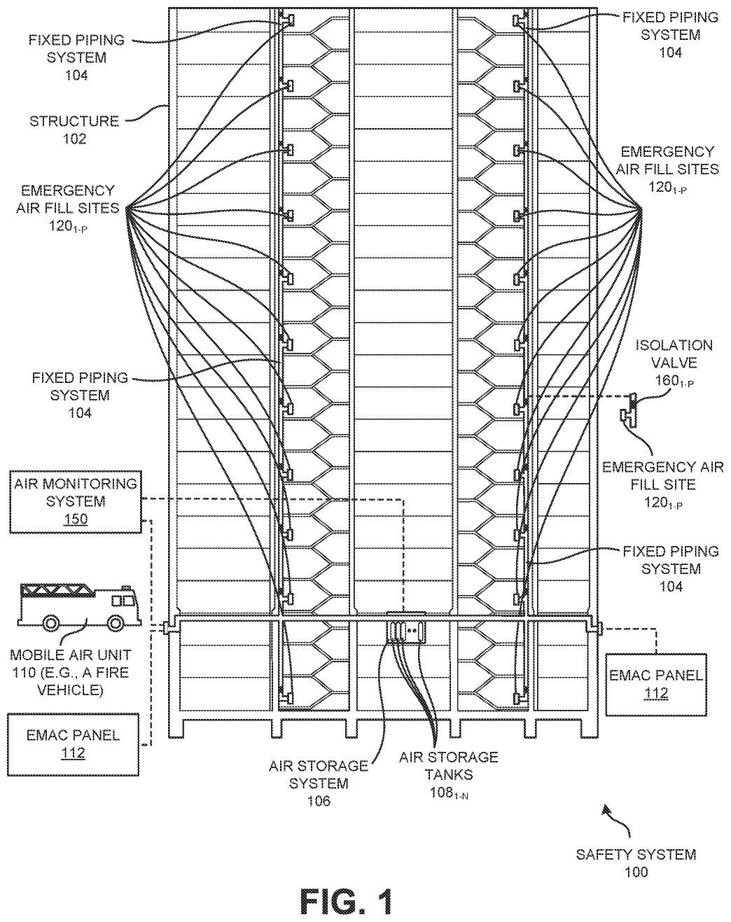

FIG. 1 shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air in-house without the need of bringing in canisters/cylinders to be transported up several flights of stairs of structure 102 or deep thereinto. In one or more embodiments, safety system 100 may supply air provided from a supply of air tanks (to be discussed) stored in structure 102. When a fire department vehicle arrives at structure 102 during an emergency, air supply typically may be provided through a source of air connected to said vehicle. In one or more embodiments, safety system 100 may enable firefighters to refill canisters/air cylinders thereof at emergency air fill sites (to be discussed) located throughout structure 102. Specifically, in some embodiments, firefighters may be able to fill canisters/air cylinders thereof at emergency air fill sites within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels and marine craft (e.g., large marine vessels such as cruise ships, cargo ships, submarines and large naval craft, which may be “floating” versions of buildings and horizontal structures). In one or more embodiments, safety system 100 may include a fixed piping system 104 permanently installed within structure 102 serving as a constant source of replenishment of breathable air. Fixed piping system 104 may be regarded as being analogous to a water piping system within structure 102 or another structure analogous thereto for the sake of imaginative convenience.

As shown in FIG. 1, fixed piping system 104 may distribute/supply air across floors/levels of structure 102 and, generally, across structure 102/safety system 100. For the aforementioned purpose, fixed piping system 104 may distribute air from an air storage system 106 (e.g., within structure 102) including a number of air storage tanks 108_{1-N} that serve as sources of pressurized air. Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air in canisters/air cylinders (e.g., utilizable with Self-Contained Breathing Apparatuses (SCBAs) carried by firefighters). Mobile air unit 110 may also include other pieces of air supply/distribution equipment (e.g., piping and/or canisters/air cylinders) that may be able to leverage the sources of breathable air within safety system 100 through EMAC panel 112. Firefighters, for example, may be able to fill air into canisters/air cylinders (e.g., spare bottles, bottles requiring replenishment of breathable air) carried on mobile air unit 110 through safety system 100.

In FIG. 1, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air within safety system 100. FIG. 1 shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (not shown) within air monitoring system 150 may automatically sense and record the pressure of the breathable air of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety threshold.

In one or more embodiments, fixed piping system 104 may include pipes (e.g., constituted out of stainless steel tubing) that distribute breathable air to a number of emergency air fill sites 120_{1-P} within structure 102. In one example implementation, each emergency air fill site 120_{1-P} may be located at a specific level of structure 102. If structure 102 is regarded as a vertical building structure, an emergency air fill site 120_{1-P} may be located at each of a basement level, a first floor level, a second floor level and so on. For example, emergency air fill site 120_{1-P} may be located at the end of the flight of stairs that emergency fighting personnel (e.g., firefighting personnel) need to climb to reach a specific floor level within the vertical building structure.

In one or more embodiments, an emergency air fill site 120_{1-P} may be a static location within a level of structure 102 that provides emergency personnel (e.g., firefighters) with the ability to rapidly fill canisters/air cylinders (e.g., SCBA cylinders). In one or more embodiments, emergency air fill site 120_{1-P} may be an emergency air fill panel or a rupture containment air fill station. In one or more embodiments, proximate each emergency air fill site 120_{1-P}, safety system 100 may include an isolation valve 160_{1-P} to isolate a corresponding emergency air fill site 120_{1-P} from a rest of safety system 100. For example, said isolation may be achieved through the manual turning of isolation valve 160_{1-P} proximate the corresponding emergency air fill site 120_{1-P} or remotely from air monitoring system 150. In one example implementation, air monitoring system 150 may maintain breathable air supply to a subset of emergency air fill sites 120_{1-P} through control of a corresponding subset of isolation valves 160_{1-P} and may isolate the other emergency air fill sites 120_{1-P} from the breathable air supply. It should be noted that configurations and components of safety system 100 may vary from the example safety system 100 of FIG. 1.

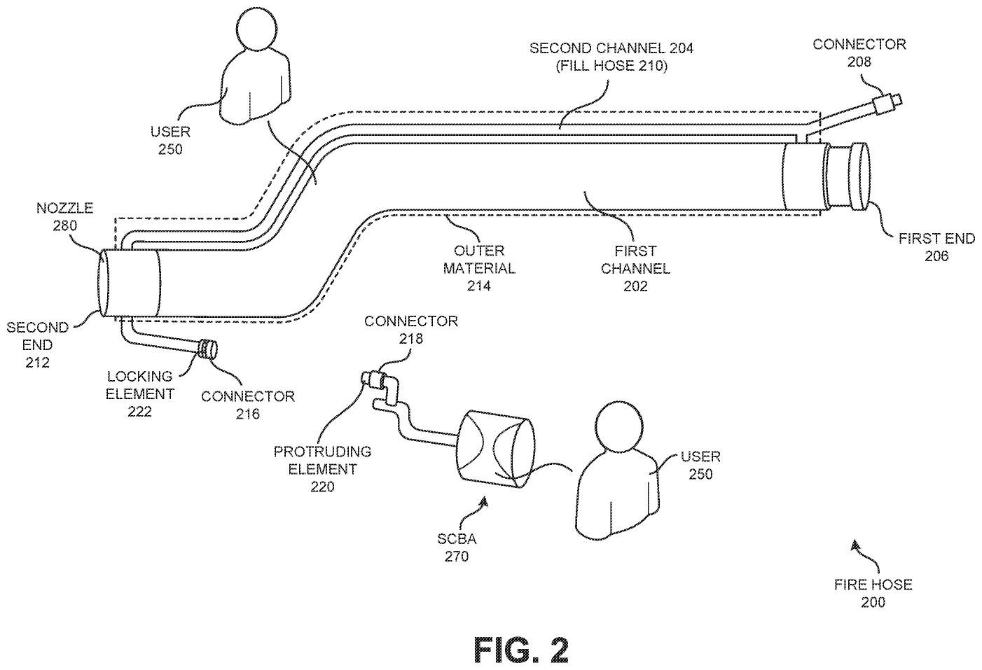

FIG. 2 shows an example fire hose 200 (e.g., carried through mobile air unit 110), according to one or more embodiments. In one or more embodiments, fire hose 200 may be employed by a user 250 (e.g., a firefighter, emergency personnel) to extinguish a fire associated with structure 102; user 250 may also utilize fire hose 200 for test, trial and/or maintenance related purposes. In one or more embodiments, fire hose 200 may be configured to carry a fire suppression agent (e.g., a firefighting fluid in general, water, aqueous film-forming foam, compositions containing water) through a first channel 202 thereof. In one or more embodiments, fire hose 200 may also include a second channel 204 separate from first channel 202 that is configured to carry breathable air (e.g., a regulated, low-pressure volume thereof) therethrough.

In one or more embodiments, as seen in FIG. 2, a first end 206 of fire hose 200 may be provided with a connector 208 (e.g., an adapter). In one or more embodiments, this connector 208 may be communicatively coupled to second channel 204 that is separate from first channel 202. For the aforementioned purpose, in one or more embodiments, connector 208 may include an air passage (not shown) therein to establish an air connection between connector 208, second channel 204 and emergency air fill site 120_{1-P} (as will be discussed below). In one or more embodiments, second channel 204 may be constituted by a fill hose 210 coursing through fire hose 200 to a second end 212 thereof. In other words, fill hose 210 may extend along an entire length of first channel 202, according to one or more embodiments. In one or more embodiments, first channel 202 and second channel 204 may be contained within the same outer material 214 (e.g., a synthetic fiber such as nylon, cotton and/or rubber). FIG. 2 shows outer material 214 as transparent merely for the sake of illustrative convenience and clarity. In one or more embodiments, at second end 212, fire hose 200 may include a nozzle 280 (serving also as an end of first channel 202) to direct a stream of the fire suppression agent at a target location. In some implementations, nozzle 280 may be made of brass. It should be noted that other components of fire hose 200 and variations therein are within the scope of the exemplary embodiments discussed herein.

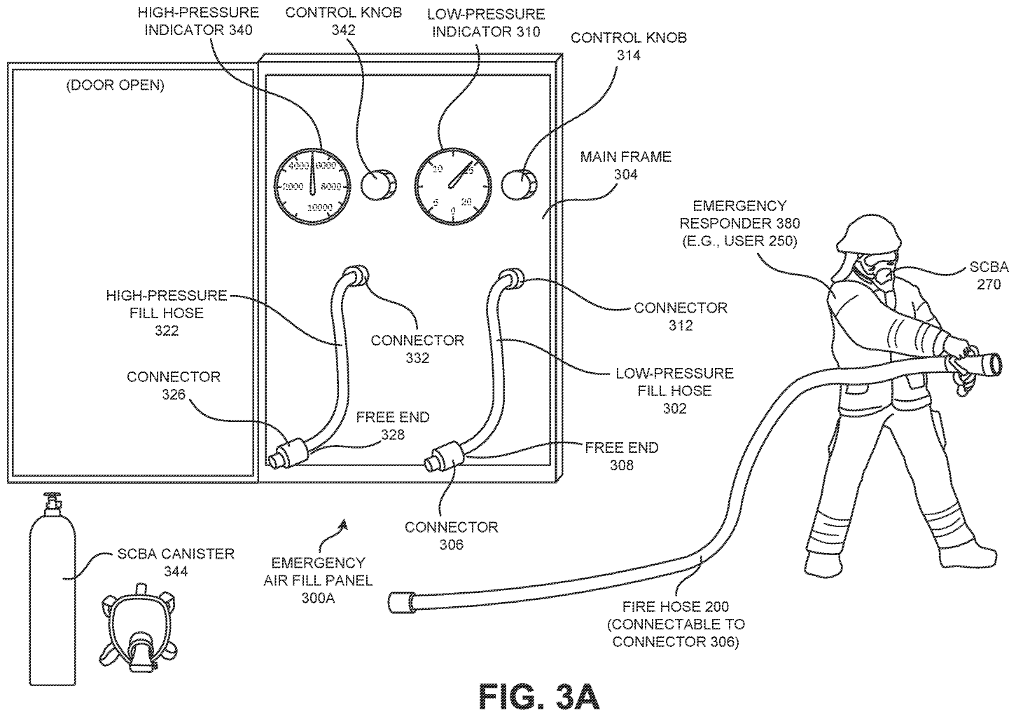

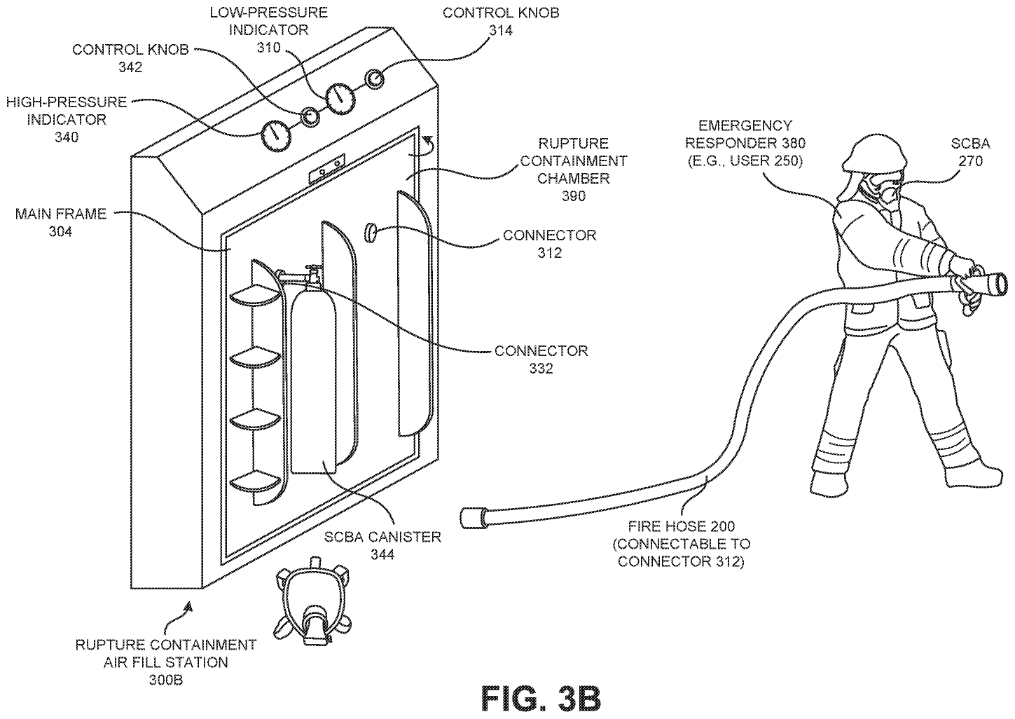

FIG. 3A shows an emergency air fill panel 300A as an example emergency air fill site 120_{1-P}, according to one or more embodiments (dual port, both high pressure and low pressure). In one or more embodiments, as seen above, emergency air fill panel 300A may be connected/coupled to fixed piping system 104 serving as a source of breathable air. In one or more embodiments, a typical emergency air fill site 120_{1-P} may enable firefighters/emergency personnel to rapidly fill canisters/cylinders thereof (high pressure). However, in one or more embodiments, emergency air fill panel 300A, as discussed herein, may enable firefighters/emergency personnel to integrate fire hose 200 therewith (low pressure). Pressure regulators may limit what is filled in any one port. Moreover, for safety, the connector types of various PSI based connectors may be different and there may be safety measures put in place to ensure that a low pressure is maintained for breathable masks through a set of valves (e.g., pressure regulatory valves). Moreover, in one or more embodiments, emergency air fill panel 300A may include one or more ports that output breathable air at high pressures (e.g., 4500 Pounds Per Square Inch (PSI), 5500 PSI) and low pressures (e.g., pressures conductive for human breathing such as 14.7 PSI), and thereby having dual pressure ports. For the aforementioned purpose, in one or more embodiments, a high-pressure fill hose 322 and a low-pressure fill hose 302 may protrude from a main frame 304 of emergency air fill panel 300A.

In one or more embodiments, high-pressure fill hose 322 may have a connector 326 at a free end 328 thereof. Similarly, in one or more embodiments, low-pressure fill hose 302 may have a connector 306 at a free end 308 thereof. It should be noted that high-pressure fill hose 322 and low-pressure fill hose 302 may be connected to main frame 304 of emergency air fill panel 300A through connector 332 and connector 312 respectively provided on main frame 304. In one or more embodiments, high-pressure fill hose 322 and low-pressure fill hose 302 may, thus, extend from main frame 304 to free end 328 and free end 308 respectively. As seen in FIG. 3A, high-pressure fill hose 322 may be utilized to connect to a Self-Contained Breathing Apparatus (SCBA) canister 344 (e.g., part of a standard SCBA with face masks/respirators and the requisite adapters) in order to fill said SCBA canister 344 with breathable air at high-pressure.

In one or more embodiments, emergency air fill panel 300A connected to fixed piping system 104 may port a regulated, low-pressure volume of the breathable air through low-pressure fill hose 302. In one or more embodiments, connector 306 at free end 308 may be connectably complementary to connector 208 such that, upon connection of connector 306 to connector 208, emergency air fill panel 300A connected to fixed piping system 104 may port the regulated, low-pressure volume of the breathable air through low-pressure fill hose 302 to fire hose 200.

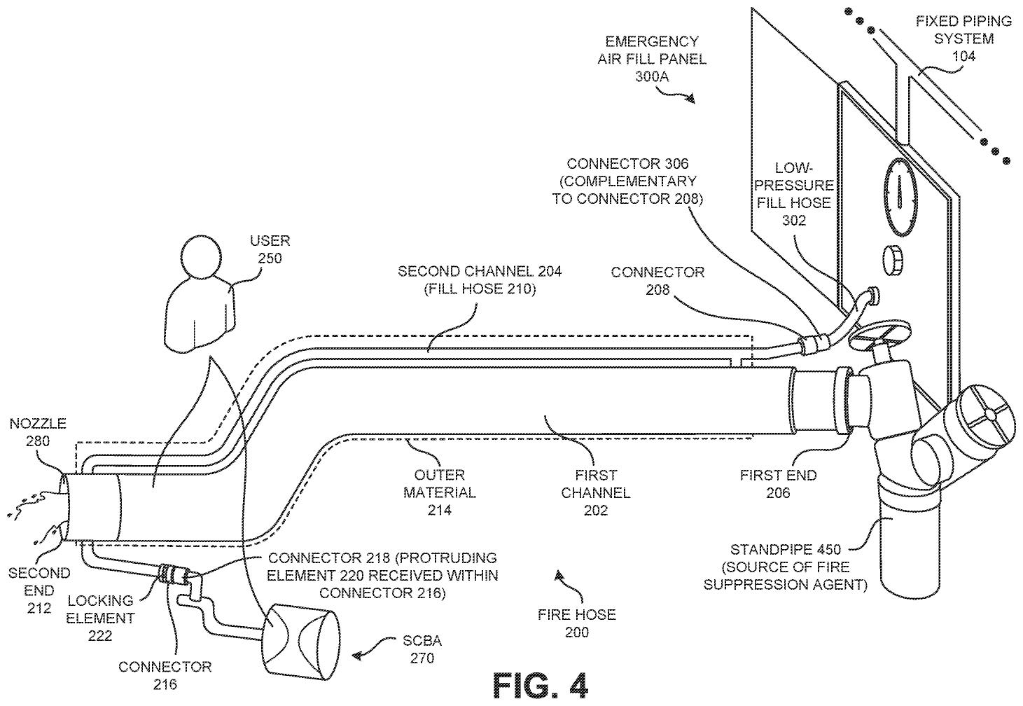

For example, connector 208 may be a “male” element of the connection and connector 306 may be the “female” element thereof. In another implementation, connector 208 may be the “female” element of the connection and connector 306 the “male” element thereof. In one or more embodiments, connection of connector 208 to connector 306 may supply the regulated, low-pressure volume of the breathable air through second channel 204 to an SCBA 270 of user 250. In one or more embodiments, emergency air fill panel 300A may be lockable; FIG. 3A shows a door of emergency air fill panel 300A being open for illustrative purposes. FIG. 4 shows the connection between connector 306 of emergency air fill panel 300A/rupture containment air fill station 300B (to be discussed below) and connector 208 of fire hose 200, according to one or more embodiments. FIG. 3A also shows an emergency responder 380 (e.g., user 250) utilizing fire hose 200 integrable with emergency air fill panel 300A to supply the regulated, low-pressure volume of the breathable air to SCBA 270 thereof.

In one or more embodiments, emergency air fill panel 300A may also include a high-pressure indicator 340 (e.g., a pressure gauge) to indicate a high-pressure (e.g., 4500 PSI, 5500 PSI) at which breathable air may be supplied and/or to indicate a current pressure level of the breathable air in safety system 100, and a control knob 342 to adjust the pressure at which high-pressure breathable air may be ported out of high-pressure fill hose 322. In one or more embodiments, emergency air fill panel 300A may also include a low-pressure indicator 310 to indicate a low-pressure (e.g., 14.7-15 PSI or slightly higher or lower) at which breathable air may be supplied, and a control knob 314 to adjust the pressure at which second channel 204 of fire hose 200 may be filled with a regulated, low-pressure volume of breathable air such that said pressure does not exceed a safety threshold thereof. Although FIG. 3A shows two pressure indicators 310 and 340, it should be noted that any number of indicators is within the scope of the exemplary embodiments discussed herein. Additionally, it should be noted that there may be other components of emergency air fill panel 300A. It should be noted that safety system 100 may include pressure regulators and/or pressure valves to control a system pressure from a high level to one that is conducive for human breathing (e.g., 14.7-15 PSI or slightly above or below). All reasonable variations are within the scope of the exemplary embodiments discussed herein.

FIG. 3B shows a rupture containment air fill station 300B as an example emergency air fill site 120_{1-P}, according to one or more embodiments. In one or more embodiments, rupture containment air fill station 300B may include a rotatable rupture containment chamber 390 that includes connectors 332 and 312 provided on a main frame 304 thereof. It is obvious that connectors 332 and 312 and main frame 304 are similar to counterparts thereof in FIG. 3A. However, in rupture containment air fill station 300B, SCBA canister 344 may directly be connected to connector 332, as shown in FIG. 3B. Further, in one or more embodiments, connector 312 may itself be connectably complementary (e.g., based on “male”/“female” coupling) to connector 208 of fire hose 200, thereby making it possible for fire hose 200 to be directly connected to connector 312 without the requirement of a fill-hose therefor. In one or more embodiments, the connectability of fire hose 200 of emergency responder 380 to connector 312 of rupture containment fill station 300B may be similar to the connectability of fire hose 200 of emergency responder 380 to connector 306 of low-pressure fill hose 302 demonstrated in FIG. 3A.

It should be noted that rupture containment air fill station 300B may also include high-pressure/low-pressure indicator 340/310 and control knob 342/314 serving the same purpose as discussed with regard to FIG. 3A. In one or more embodiments, the purpose of rupture containment chamber 390 may be to contain any canister explosions therewithin. For the aforementioned purpose, rupture containment chamber 390 may be rotatable such that SCBA canister 344 may be contained therewithin in a way that SCBA canister 344 is invisible to user 250/emergency responder 380. All relevant discussions associated with FIG. 3A are also applicable to FIG. 3B.

Referring back to FIG. 2 and FIG. 4, which shows the connected state of fire hose 200 and emergency air fill panel 300A/rupture containment air fill station 300B, fill hose 210 may include a connector 216 proximate second end 212 of fire hose 200. In one or more embodiments, this connector 216 may be coupled (or couplable) to a connector 218 of SCBA 270 of user 250. Again, in one or more embodiments, the connection between connector 216 and connector 218 may be based on “male”/“female” elements, whereby connector 216 or connector 218 is the “male” element of the connection and connector 218 or connector 216 is the “female” element thereof. For example, as shown in FIG. 4, connector 216 may be a “female” component of the connection and connector 218 the “male” component thereof. In one or more embodiments, connector 218 may include a protruding element 220 thereof that is received within connector 216 to enable a locking element 222 of connector 216 lock on to connector 218. All reasonable variations are within the scope of the exemplary embodiments discussed herein.

Also, in one or more embodiments, FIG. 4 shows a standpipe 450 at the same level at which emergency air fill panel 300A is located within structure 102. In one or more embodiments, standpipe 450 may be a vertical pipe extending from a supply of the fire suppression agent; standpipe 450 may have ports to which one or more fire hoses (e.g., fire hose 200) may be connected. Thus, standpipe 450 may be regarded as a source of the fire suppression agent. FIG. 4 shows first end 206 of fire hose 200 being connected to a port of standpipe 450. Thus, nozzle 280 of fire hose 200 may eject said fire suppression agent out of fire hose 200 at a target, when fire hose 200 is supplying the regulated, low-pressure volume of the breathable air to SCBA 270. It should be noted that SCBA 270, as discussed herein, may be related to SCBAs (including face masks) with or without canisters. Exemplary embodiments, as discussed herein, may enable SCBAs (e.g., SCBA 270) without canisters to be supplied with the regulated, low-pressure volume of the breathable air from emergency air fill panel 300A via fire hose 200.

It should be noted that each of connector 208, connector 306, connector 312, connector 216 and connector 218 may include an air passage (not shown) to maintain an air connection therebetween during supply of the regulated, low-pressure volume of the breathable air. In one or more embodiments, the connection between connector 306 (or, connector 312 in the case of rupture containment air fill station 300B of FIG. 3B) and connector 208 may supply the regulated, low-pressure volume of the breathable air through second channel 204 to second end 212 of fire hose 200, to which SCBA 270 of user 250 is connected (e.g., by way of connector 216 and connector 218). In one or more embodiments, user 250 may, thus, be supplied with the regulated, low-pressure volume of the breathable air by way of SCBA 270 based on integration of fire hose 200 with emergency air fill panel 300A/rupture containment air fill station 300B. All reasonable variations are within the scope of the exemplary embodiments discussed herein.

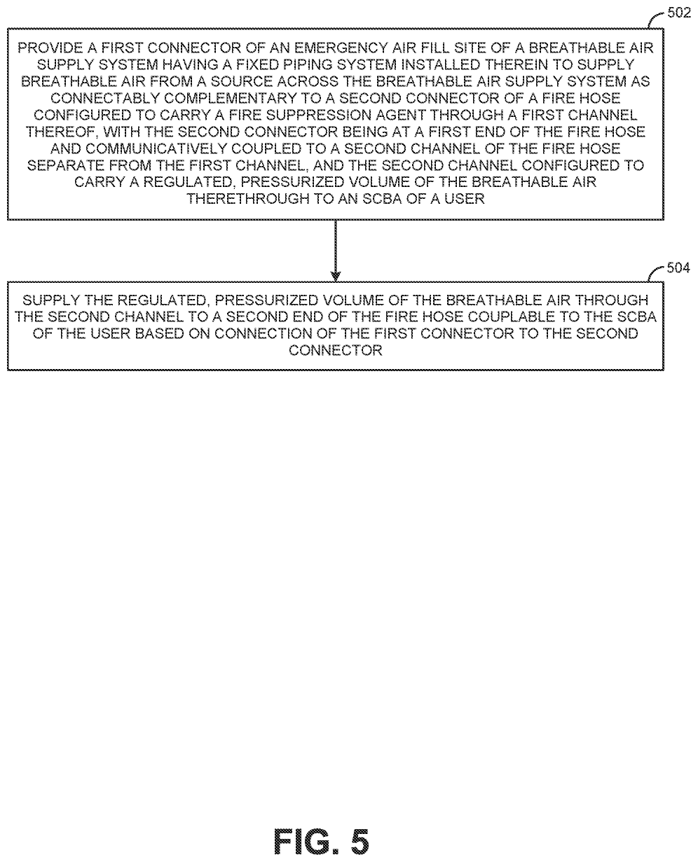

FIG. 5 shows a process flow diagram detailing the operations involved in integrating a fire hose (e.g., fire hose 200) with a breathable air supply system (e.g., safety system 100), according to one or more embodiments. In one or more embodiments, the breathable air supply system may be within a structure (e.g., structure 102) having a fixed piping system (e.g., fixed piping system 104) installed therein to supply breathable air from a source (e.g., air storage system 106) across the breathable air supply system including an emergency air fill site (e.g., emergency air fill site 120_{1-P}, emergency air fill panel 300A, rupture containment air fill station 300B) configured to port a regulated pressurized volume of the breathable air out through a first connector (e.g., connector 306 in the case of emergency air fill panel 300A of FIG. 3A, and connector 312 in the case of rupture containment air fill station 300B of FIG. 3B) thereof. In one or more embodiments, the fire hose may be configured to carry a fire suppression agent through a first channel (e.g., first channel 202) thereof

In one or more embodiments, operation 502 may involve providing the first connector as being connectably complementary to a second connector (e.g., connector 208) of the fire hose. In one or more embodiments, the second connector may be at a first end (e.g., first end 206) of the fire hose and communicatively coupled to a second channel (e.g., second channel 204) of the fire hose separate from the first channel. In one or more embodiments, the second channel may be configured to carry the regulated, pressurized volume of the breathable air therethrough to an SCBA (e.g., SCBA 270) of a user (e.g., user 250, emergency responder 380). In one or more embodiments, operation 504 may then involve supplying the regulated, pressurized volume of the breathable air through the second channel to a second end (e.g., second end 212) of the fire hose couplable to the SCBA of the user based on connection of the first connector to the second connector.

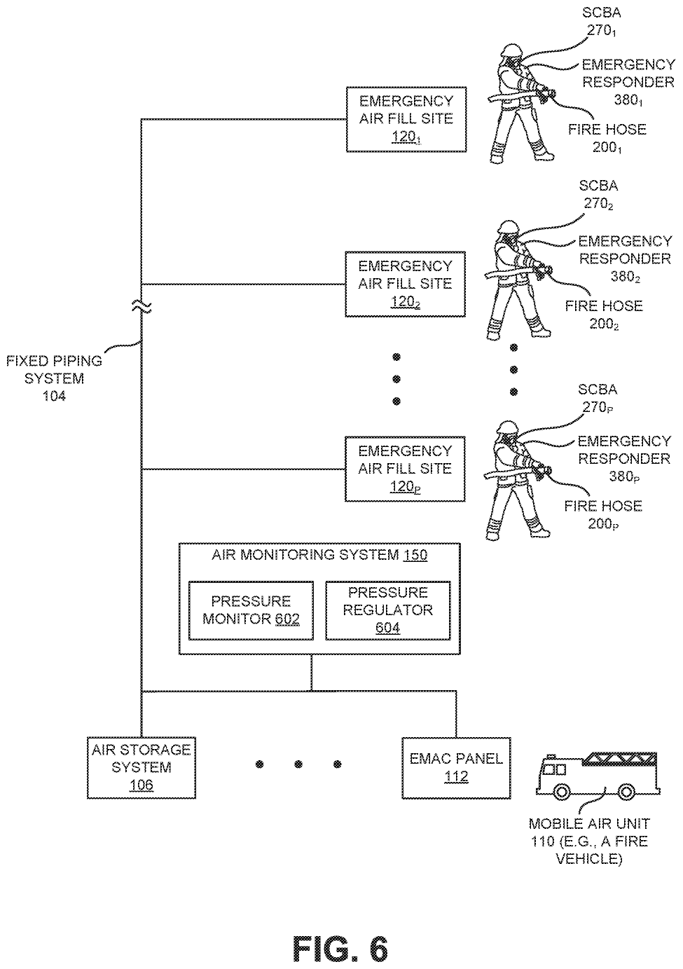

FIG. 6 shows another layout of safety system 100 with emergency responders 380_{1-P} (examples of user 250) at each level of structure 102, according to one or more embodiments. Here, in one or more embodiments, each emergency responder 380_{1-P} may possess the capability to integrate fire hoses 200_{1-P} (analogous to fire hose 200) thereof with a corresponding emergency air fill site 120_{1-P} (emergency air fill panel 300A, rupture containment air fill station 300B) and leverage the regulated, low-pressure volume of the breathable air discussed above for SCBAs 270_{1-P} (analogous to SCBA 270) thereof. FIG. 6 also shows air monitoring system 150 of safety system 100 as including a pressure monitor 602 configured to monitor system pressure and a pressure regulator 604 configured to regulate the system pressure, according to one or more embodiments. In one or more embodiments, pressure regulator 604 may regulate the system pressure to enable the regulated, low-pressure volume of the breathable air (e.g., at 14.7-15 PSI or slightly higher or lower) to be ported out of low-pressure fill hose 302 in the case of emergency air fill panel 300A or connector 312 in the case of rupture containment air fill station 300B, as discussed above. All reasonable variations are within the scope of the exemplary embodiments discussed herein.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A breathable air supply system within a structure comprising:
a fixed piping system permanently installed within the structure serving as a source of breathable air; and
an emergency air fill site communicatively coupled to the fixed piping system to port a regulated, pressurized volume of the breathable air out through a first connector thereof,
wherein the first connector is connectably complementary to a second connector of a fire hose configured to carry a fire suppression agent through a first channel thereof, the second connector being at a first end of the fire hose and communicatively coupled to a second channel of the fire hose separate from the first channel, and the second channel configured to carry the regulated, pressurized volume of the breathable air therethrough to a Self-Contained Breathing Apparatus (SCBA) of a user, and
wherein connection of the first connector to the second connector supplies the regulated, pressurized volume of the breathable air through the second channel to a second end of the fire hose couplable to the SCBA of the user.

2. The breathable air supply system of claim 1, wherein at least one of:
the emergency air fill site communicatively coupled to the fixed piping system is one of: an emergency air fill panel and a rupture containment air fill station stationed at a level within the structure, and
the first connector is at a free end of a fill hose extending from the emergency air fill panel.

3. The breathable air supply system of claim 2, wherein the second channel is constituted by another fill hose coursing through the fire hose to the second end thereof.

4. The breathable air supply system of claim 3, wherein the emergency air fill panel further comprises a third connector provided on a main frame thereof to which the fill hose is connected and from which the fill hose extends to the free end thereof.

5. The breathable air supply system of claim 4, wherein the another fill hose is couplable to the fill hose of the emergency air fill panel.

6. The breathable air supply system of claim 5, wherein the another fill hose comprises a fourth connector proximate the second end of the fire hose couplable to a fifth connector of the SCBA.

7. The breathable air supply system of claim 6, wherein the fourth connector of the another fill hose and the fifth connector of the SCBA are a female component and a male component respectively of a coupling therebetween such that the fourth connector receives a protruding element of the fifth connector therein and locks on to the fifth connector by way of a locking element of the fourth connector.

8. A breathable air supply system within a structure comprising:
a fixed piping system permanently installed within the structure serving as a source of breathable air;
an emergency air fill site communicatively coupled to the fixed piping system to port a regulated, pressurized volume of the breathable air out through a first connector thereof; and
a fire hose configured to carry a fire suppression agent through a first channel thereof and to carry the regulated, pressurized volume of the breathable air through a second channel thereof to an SCBA of a user, the second channel being separate from the first channel, and the fire hose comprising a second connector at a first end thereof communicatively coupled to the second channel,
wherein the first connector is connectably complementary to the second connector of the fire hose, and
wherein connection of the first connector to the second connector supplies the regulated, pressurized volume of the breathable air through the second channel to a second end of the fire hose couplable to the SCBA of the user.

9. The breathable air supply system of claim 8, wherein at least one of:
the emergency air fill site communicatively coupled to the fixed piping system is one of: an emergency air fill panel and a rupture containment air fill station stationed at a level within the structure, and
the first connector is at a free end of a fill hose extending from the emergency air fill panel.

10. The breathable air supply system of claim 9, wherein the second channel is constituted by another fill hose coursing through the fire hose to the second end thereof.

11. The breathable air supply system of claim 10, wherein the emergency air fill panel further comprises a third connector provided on a main frame thereof to which the fill hose is connected and from which the fill hose extends to the free end thereof.

12. The breathable air supply system of claim 11, wherein the another fill hose is couplable to the fill hose of the emergency air fill panel.

13. The breathable air supply system of claim 12, wherein the another fill hose comprises a fourth connector proximate the second end of the fire hose couplable to a fifth connector of the SCBA.

14. The breathable air supply system of claim 13, wherein the fourth connector of the another fill hose and the fifth connector of the SCBA are a female component and a male component respectively of a coupling therebetween such that the fourth connector receives a protruding element of the fifth connector therein and locks on to the fifth connector by way of a locking element of the fourth connector.

15. A method of integration of a fire hose configured to carry a fire suppression agent through a first channel thereof with a breathable air supply system within a structure having a fixed piping system installed therein to supply breathable air from a source across the breathable air supply system including an emergency air fill site configured to port a regulated, pressurized volume of the breathable air out through a first connector thereof, comprising:
providing the first connector of the emergency air fill site as connectably complementary to a second connector of the fire hose, the second connector being at a first end of the fire hose and communicatively coupled to a second channel of the fire hose separate from the first channel, and the second channel configured to carry the regulated, pressurized volume of the breathable air therethrough to an SCBA of a user; and
supplying the regulated, pressurized volume of the breathable air through the second channel to a second end of the fire hose couplable to the SCBA of the user based on connection of the first connector to the second connector.

16. The method of claim 15, comprising at least one of:
the emergency air fill site being one of: an emergency air fill panel and a rupture containment air fill station stationed at a level within the structure; and
the first connector being at a free end of a fill hose extending from the emergency air fill panel.

17. The method of claim 16, comprising the second channel being constituted by another fill hose coursing through the fire hose to the second end thereof.

18. The method of claim 17, comprising providing a third connector on a main frame of the emergency air fill panel to which the fill hose is connected and from which the fill hose extends to the free end thereof.

19. The method of claim 18, comprising the another fill hose being couplable to the fill hose of the emergency air fill panel.

20. The method of claim 19, comprising at least one of:
providing the another fill hose with a fourth connector proximate the second end of the fire hose couplable to a fifth connector of the SCBA; and
providing the fourth connector of the another fill hose and the fifth connector of the SCBA as a female component and a male component respectively of a coupling therebetween such that the fourth connector receives a protruding element of the fifth connector therein and locks on to the fifth connector by way of a locking element of the fourth connector.
